(19) United States
(12) Patent Application Publication
(10) Pub. No.: US 2007/0157025 A1
(43) Pub. Date: Jul. 5, 2007

(54) Method and system for providing security and reliability to collaborative applications

(75) Inventors: Manoj R. Sastry, Portland, OR (US); Deepak J. Manohar, Hillsboro, OR (US); Michael J. Covington, Hillsboro, OR (US); Farid Adrangi, Lake Oswego, OR (US); Shao-Cheng Wang, Los Angeles, CA (US)

Correspondence Address: INTEL CORPORATION;c/o INTELLEVATE, LLC, P.O. BOX 52050, MINNEAPOLIS, MN, 55402, US

(73) Assignee: INTEL CORPORATION

(21) Appl. No.: 11/322,683

(22) Filed: Dec. 30, 2005

(51) Int. Cl. G06F 21/00

(52) U.S. Cl. 713/170

(57) ABSTRACT

Some embodiments of a method and system for providing secure and reliable collaborative applications are described. In some embodiments, a collaborative application may be separated into critical and non-critical components. The critical components may be run on a secure domain on a virtual machine, apart from the non-critical components, according to some embodiments. Other embodiments are described.

### BACKGROUND

1. Technical Field

Some embodiments of the invention generally relate to virtual machines. In particular, certain embodiments relate to operating collaborative applications on virtual machines.

2. Discussion

As computing system performance improves, efforts are made to provide additional functionality to users from the computing systems. The additional functionality, however, may not provide the level of security and reliability expected or required by users.

The level of security and reliability of an application which provides the additional functionality is often limited by the platform or operating system (OS) on which the application runs. Indeed, the applications and OSes are susceptible to both benign faults and malicious crashes.

What is needed is a secure and reliable approach to providing applications to users. Furthermore, there is a need to provide the applications in a manner where users need not be informed of the approach, as the approach may not result in any change in the use of the applications by users.

### BRIEF DESCRIPTION OF THE DRAWINGS

Various advantages of embodiments of the present invention will become apparent to one skilled in the art by reading the following specification and appended claims, and by referencing the following drawings, in which:

FIG. 1 is a block diagram of secure inter-domain communication between domains according to some embodiments of the invention;

FIG. 2 is a block diagram of secure inter-domain communication between domains according to some embodiments of the invention;

FIG. 3 is a block diagram of an architecture for seamless collaboration according to some embodiments of the invention;

FIG. 4 is a system-level block diagram of a computer system according to some embodiments of the invention;

FIG. 5 is a flowchart of process for establishing inter-domain communication according to some embodiments of the invention; and

FIG. 6 is a flowchart of process for securing and making more reliable inter-domain communication according to some embodiments of the invention.

### DETAILED DESCRIPTION

In accordance with some embodiments of the present invention, there may be advantages to splitting a monolithic application into critical and non-critical components and running them in two separate domains that communicate via an inter-domain communication channel. Indeed, in some embodiments, the use of virtual machines to provide domains for the components as well as monitoring these components with a hypervisor or virtual machine monitor (VMM) may provide increased security and reliability when implemented in accordance with the invention.

The some embodiments of the invention separate applications may allow for the applications to continue their operations in their re-architected state on a virtual platform and to take advantage of the platform's virtualization capabilities to provide additional security and reliability that may result from utilizing both virtualization technology (VT) and LaGrande™ technology (LT), for example, LaGrande™ Technology Architecture Overview, a part of Intel® Corporation's Safer Computing Initiative, September 2003, Intel® Corporation, etc. It is noted, as one of ordinary skill in the relevant art(s) would appreciated, based at least on the teachings described herein, that the embodiments of the invention are not limited to applications, platforms, or processes using specific forms or versions of VT and/or LT.

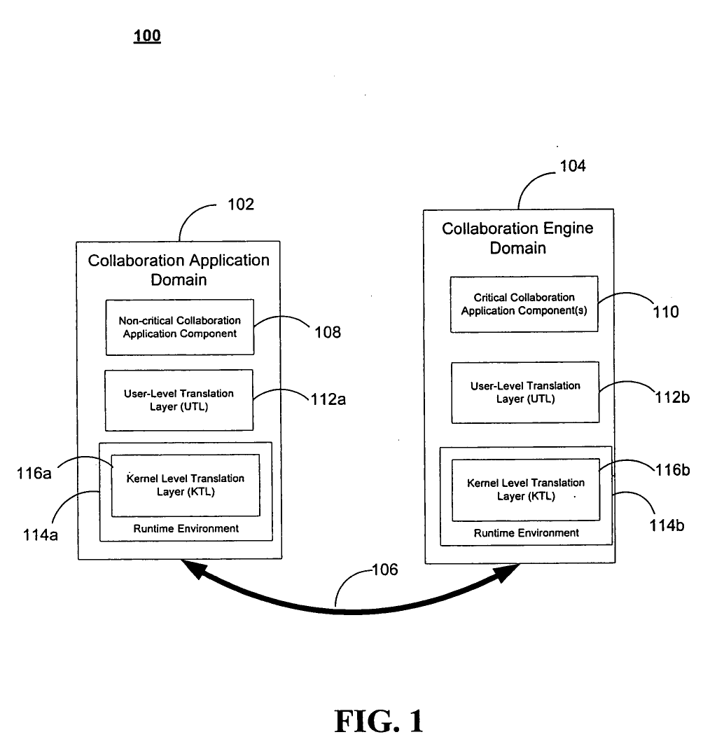

FIG. 1 is a block diagram of secure inter-domain communication between domains according to some embodiments of the invention. A system 100 illustrates some embodiments that include a collaboration application domain 102 coupled to a collaboration engine domain 104 via an inter-domain communication channel 106. According to some embodiments of the invention, the inter-domain communication channel 106 may be secure, and may further provide a) encryption for inter-domain traffic, b) parameter checking to ensure that input values are valid and c) integrity checking of the application domain 102 to ascertain that the requests received by the engine domain 104 are legitimate.

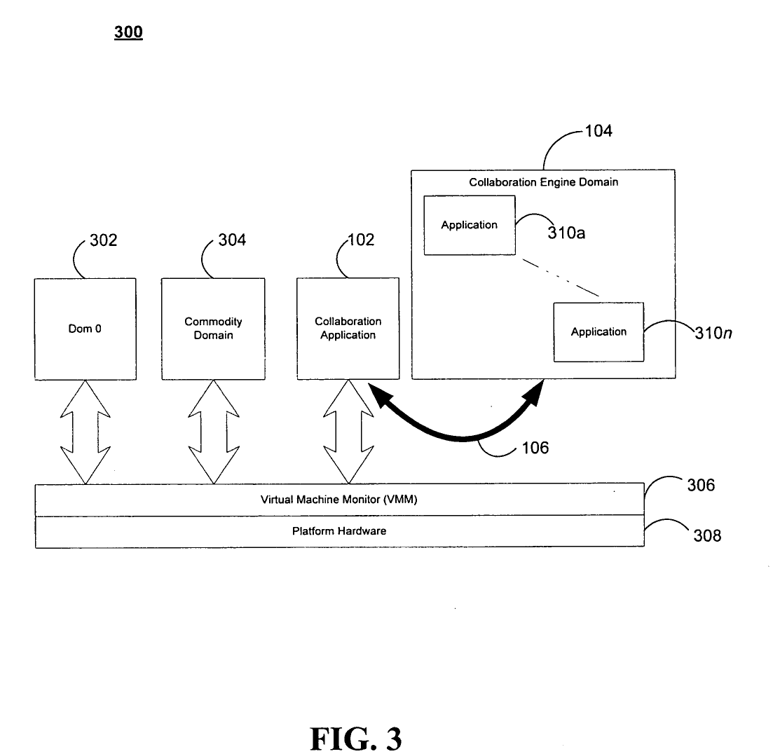

The application domain 102 may include a non-critical application component 108, in some embodiments. Furthermore, the application domain 102 may be a virtual machine, as is described in further detail below with respect to FIG. 3. In some embodiments, the application domain 102 may also include a user-level translation layer (UTL) 112a, and a kernel-level translation layer (KTL) 116a. The KTL 116a may be run within a run-time environment 114a, in some embodiments.

Moreover, in accordance with some embodiments of the invention, the UTL 112a may be adapted to transfer control from the UTL 112a to the KTL 116a, and to respond to calls from the KTL 116a. In some embodiments, the KTL 116a may be adapted to send notifications to the engine domain 104, may respond to notifications sent by the engine domain 104, may transfer control from the KTL 116a to the UTL 112a, and may transfer data between the KTL 116a and the UTL 112a.

According to some embodiments of the invention, the engine domain 104 may include a critical application component 110, and may be secure. As one of ordinary skill in the relevant art would appreciate based at least on the teachings provided herein, secure means protected against access to data by unauthorized recipients, and protected against intentional but unauthorized destruction or alteration of that data.

In some embodiments, the engine domain 104 may run a very small run-time environment 114b, thus runtime environment 114b may be more easily configured and controlled. Furthermore, in some embodiments, the engine domain 104 may be controlled by the service provider that provides the collaboration service. Hence the user may not have control over the engine domain 104 and may not tamper with it.

Furthermore, in some embodiments, the engine domain 104 may be run on a virtual machine. In some embodiments, the engine domain 104 may also include its own UTL 112b and KTL 116b, where the KTL 116b may be run in a run time environment 114b.

In some embodiments of the invention, the UTL 112b of the engine domain 104 may include a parameter check service module, an encryption service module, an integrity check service module, and a general security module (not shown). In some embodiments, the inter-domain communication between the two domains 102 and 104 may be secured by the services provided by the engine domain 104 in implementing these modules, such as, but not limited to, the following functionality:
The parameter check service module may ensure that input values used by the application domain 102 as it invokes functions in the engine domain 104 are within the specified range, in some embodiments. This may help provide immunity against buffer overflow problems caused by out-of-range input values.
The encryption service module may, in some embodiments, help protect the traffic between the engine domain 104 and the application domain 102 by encrypting the traffic using the mechanism specified by the encryption service module, which, as one of ordinary skill in the relevant art would appreciate, may be any of a number of mechanisms.
The integrity check service module, according to some embodiments, may help ensure that the integrity of the application domain 102 is intact. In some embodiments, this service may defend against a compromised seamless collaboration application. For instance, in some embodiments, a compromised application domain 102 may be infected by a virus that alters messages sent by that domain to the engine domain 104. In some embodiments, the integrity check service module may enable the engine domain 104 to detect if the application domain 102 has been compromised.
The general security module, according to some embodiments, may provide general security features, such as login/password functions, among other things. In some embodiments, this service may provide other or additional security features that may be different than the ones provided in the three other modules described above.

In accordance with some embodiments of the invention, the inter-domain communication channel 106 may be coupled to the application domain 102 and the engine domain 104, in order to link them together. As described above, the channel 106 may be secure and encrypted. Furthermore, the channel 106 may pass through and be managed by a hypervisor or VMM (shown in FIG. 3). The VMM may be coupled to the first and second virtual machines, such as 102 and 104, and to the inter-domain communication channel 106. The virtual machine monitor may supervise communication between the application domain 102 and the engine domain 104.

In some embodiments of the invention, the non-critical application component may be a graphical user interface for a voice over internet protocol (VOIP) application, and the critical application component may be a VOIP communication stack. Furthermore, in some embodiments, the non-critical application component and the critical application component are parts of a collaboration application. In some embodiments of the invention, the collaboration application may be a VOIP application, an electronic mail application, an instant messaging (IM) application, a multi-player game application, a video-on-demand application, or a secure billing application, just to name a few.

According to some embodiments of the invention, the engine domain 104 may enable, based on the elements described herein, a service provider to provide secure value added services (e.g., secure billing) that cannot be tampered with by the user.

As one of ordinary skill in the relevant art would appreciate, current authentication methods for at least VoIP-based applications may take place at the proxy. In some embodiments, the engine domain 104 may provide a framework for supplemental, secure authentication at the end point/platform to strengthen the overall authentication of the application/service.

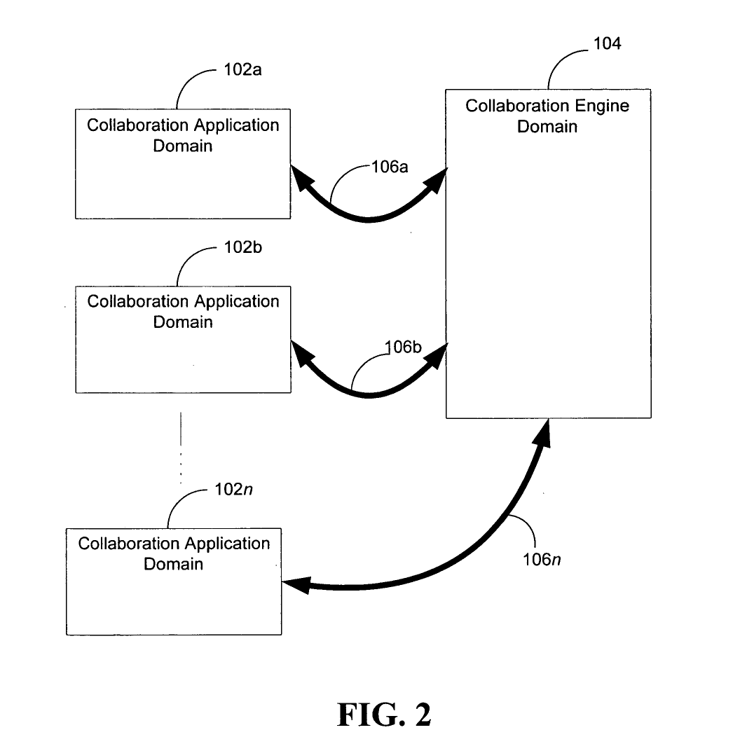

FIG. 2 is a block diagram of secure inter-domain communication between domains according to some embodiments of the invention. In some embodiments, more than one application domain 102a, and 102b - 102n may be included in the system. Each of these domains 102 may be coupled to the engine domain 104 via a separate channel 106a, and 106b - 106n respectively. Moreover, in some embodiments, more than one engine domain 104 may be included in the system (not shown).

Furthermore, within each of the multiple potential domains 102, there may be more than one non-critical application component, for example, for different types of collaborative applications, or multiple instances of the same collaborative application. Moreover, in some embodiments, more than one critical application component may be included in the engine domain 104, depending on at least the performance requirements of the applications and/or system.

FIG. 3 is a block diagram of architecture 300 for seamless collaboration according to some embodiments of the invention. As depicted in FIG. 3, in some embodiments, the platform components include platform hardware (VT/LT) 308 and a VMM (or hypervisor) 306. In some embodiments of the invention, a‘Dom 0’ 302 may be present as a special privileged domain that may provide support for device virtualization and may present virtual device models to the guest domains. As such, in accordance with some embodiments of the invention, a commodity domain 304, the application domain 102 and the engine domain 104 may be guest domains.

In some embodiments, the commodity domain 304 may include software including the operating system (OS), and similar applications which may reside in the commodity domain 304, as one of ordinary skill in the relevant art would appreciate based at least on the teachings provided herein.

As described with respect to some embodiments elsewhere herein, the critical components 310a - 310n of the collaboration application may be split and parts of it protected within the engine domain 104. In some embodiments, the non-critical (e.g., graphical user-interface (GUI)) parts of the collaboration application may be executed in the application domain 102.

In some embodiments, where the collaboration application may be a VOIP application, the critical components may contain the VOIP communication stack. In some embodiments, the user may only have access to the application domain 102, while access to the engine domain 104 may also be restricted to a specific service provider. One example of the service provider in an enterprise environment is the IT Department. Another example is 3G service providers offering VOIP services over general packet radio service (GPRS)/universal mobile telecommunications system (UMTS) for notebooks/PCs. In some embodiments, the architecture 300 may also provide secure, low-latency inter-domain communication channels 106 between the engine domain 104 and the application domain 102.

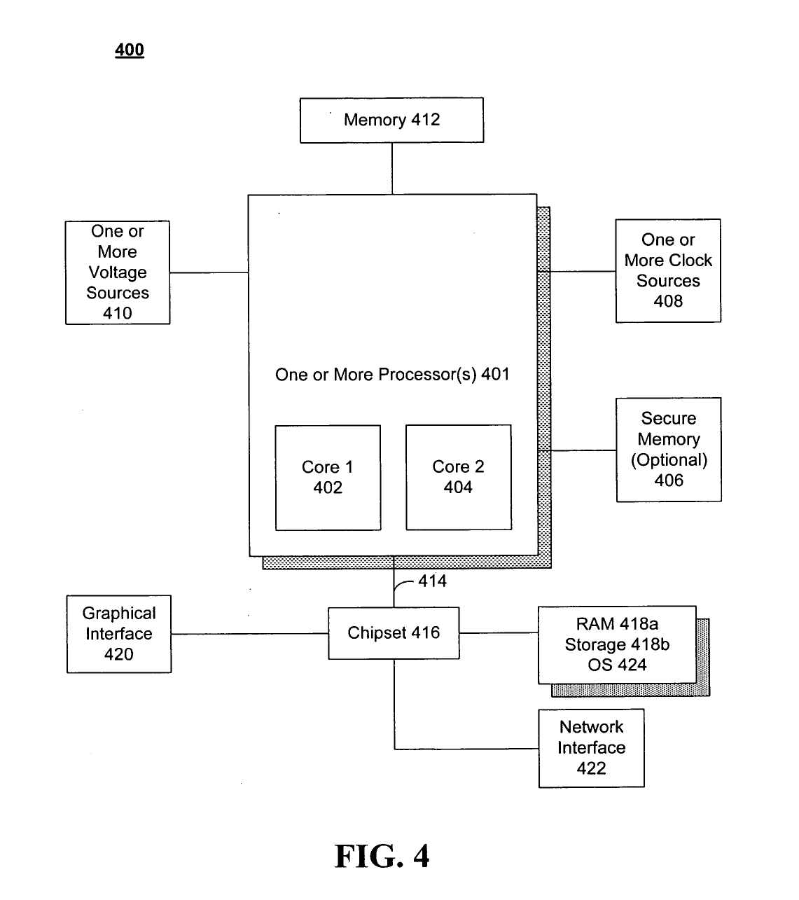

According to one or more embodiments, to enable the operations of the architecture 300 as well as the domains 102 and 104, and channel 106, a computer system or software may be employed. An example of such a computer system is described below in reference to FIG. 4.

FIG. 4 is a system-level block diagram of a computer system according to some embodiments of the invention. The computer system 400 may be a personal computer system such as, for example, a laptop, notebook or desktop computer system. The computer system 400 may include one or more processors 401, which may include sub-blocks such as, but not limited to, one or more cores, illustrated by core 402 and core 404, a secure memory 406, which may include virtualization logic for the instantiation of the VMM 306.

One or more of the processor(s) 401 may be an Intel® Architecture microprocessors. For other embodiments, the processor(s) may be a different type of processor such as, for example, a graphics processor, a digital signal processor, an embedded processor, etc. and/or may implement a different architecture.

The one or more processors 401 may be operated with one or more clock sources 408 and provided with power from one or more voltage sources 410. The one or more processors 401 may also communicate with other levels of memory, such as memory 412. Higher memory hierarchy levels such as system memory (RAM) 418a and storage 418b, such as a mass storage device which may be included within the system or accessible by the system, may be accessed via host bus 414 and a chip set 416.

In addition, other functional units such as a graphical interface 420 and a network interface 422, to name just a few, may communicate with the one or more processors 401 via appropriate busses or ports. For example, the memory 412, the RAM 418a, and/or the storage 418b may include sub-sections that provide for dynamic sizing of the memory according to embodiments of the invention. Furthermore, one of ordinary skill would recognize that some or all of the components shown may be implemented using a different partitioning and/or integration approach, in variation to what is shown in FIG. 4, without departing from the spirit or scope of the embodiment as described.

For one embodiment, the storage 418b may store software such as, for example an operating system 424. For one embodiment, the operating system is a Windows® operating system, available from Microsoft Corporation of Redmond, Washington, that includes features and functionality according to the Advanced Configuration and Power Interface (ACPI) Standard (for example, ACPI Specification, Rev. 3.0, Sep. 2, 2004; Rev. 2.0c, Aug. 25, 2003; Rev. 2.0, Jul. 27, 2000, etc.) and/or that provides for Operating System-directed Power Management (OSPM). For other embodiments, the operating system may be a different type of operating system such as, for example, a Linux operating system.

While the system 400 is a mobile personal computing system, other types of systems such as, for example, other types of computers (e.g., handhelds, servers, tablets, web appliances, routers, etc.), wireless communications devices (e.g., cellular phones, cordless phones, pagers, personal digital assistants, etc.), computer-related peripherals (e.g., printers, scanners, monitors, etc.), entertainment devices (e.g., televisions, radios, stereos, tape and compact disc players, video cassette recorders, camcorders, digital cameras, MP3 (Motion Picture Experts Group, Audio Layer 3) players, video games, watches, etc.), and the like are also within the scope of various embodiments. The memory circuits represented by the various foregoing figures may also be of any type and may be implemented in any of the above-described systems.

While many specifics of some embodiments have been described above, it will be appreciated that other approaches for providing secure and reliable collaborative applications may be implemented with other systems and/or architectures. For example, while specific collaborative applications are mentioned above, for other embodiments, other applications may be considered based at least on how access to components of the application may be divided to provide for security and reliability.

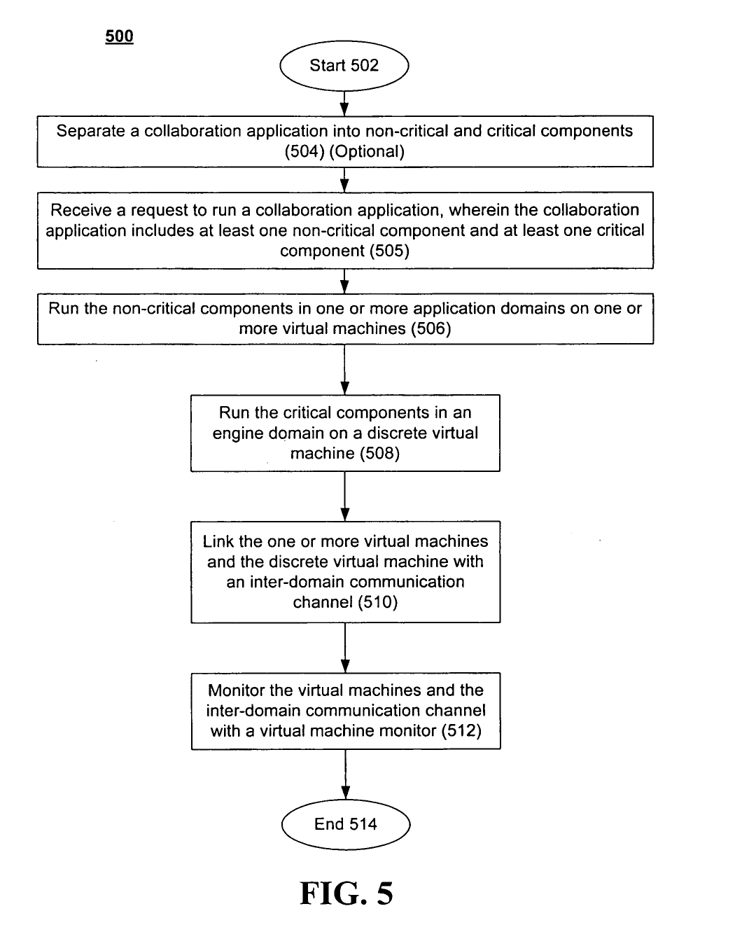

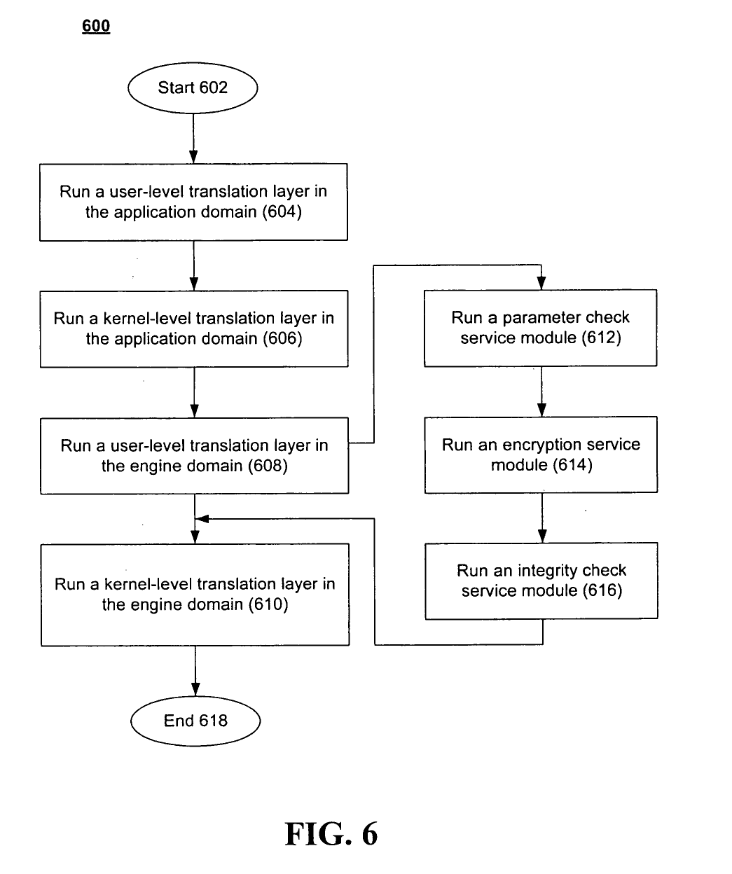

Embodiments of the present invention may include methods of performing the functions discussed in the foregoing description. For example, some embodiments of the invention may include a method for monitoring applications and/or domains, and adjusting the channels coupling them. The methods may include additional operations, some embodiments of which are described below with respect to FIGS. 5 and 6.

FIG. 5 is a flowchart of process 500 for establishing inter-domain communication according to some embodiments of the invention. The process 500 may begin at 502 and may proceed to 504, which is an optional operation that may occur prior to the operations of some embodiments, where it may separate a collaboration application into a non-critical component and a critical component, according to some embodiments of the invention. The process may then proceed to 505, where it may, in some embodiments, receive a request to run a collaboration application, wherein the collaboration application includes at least one non-critical component and at least one critical component. The process may then proceed to 506, where it may, in some embodiments, run the non-critical component in an application domain on a first virtual machine. After 506, the process may then proceed to 508, where it may run the critical component in an engine domain on a second virtual machine, according to some embodiments. Furthermore, in some embodiments, the process 500 may proceed to 510, where it may link the first and second virtual machines with an inter-domain communication channel.

Moreover, in some embodiments, the process 500 may optionally proceed to 512, where it may monitor the first and second virtual machines, and the inter-domain communication channel with a virtual machine monitor, wherein the virtual machine monitor supervises communication between the application domain and the engine domain.

FIG. 6 is a flowchart of process 600 for securing and making more reliable inter-domain communication according to some embodiments of the invention. The process may being at 602 and proceed to 604, where it may run a user-level translation layer in the application domain, in some embodiments of the invention. The process 600 may then proceed to 606, in some embodiments, where it may run a kernel-level translation layer in the application domain, wherein the user-level translation layer is adapted to transfer control from the user-level translation layer to the kernel-level translation layer, and to respond to calls from the kernel-level translation layer, and wherein the kernel-level translation layer is adapted to send notifications to the engine domain, to respond to notifications sent by the engine domain, to transfer control from the kernel-level translation layer to the user-level translation layer, and to transfer data between the kernel-level translation layer and the user-level translation layer.

Moreover, in some embodiments, the process 600 may then proceed to 608, where it may run a user-level translation layer in the engine domain, and furthermore, in some embodiments, it may proceed to 610, where it may run a kernel-level translation layer in the engine domain.

According to some embodiments of the invention, the process 600 at 608 may also include the operations of running a parameter check service module (612), running an encryption service module (614), and running an integrity check service module (616). As one of ordinary skill in the relevant art(s) would appreciate, based at least on the teachings described herein, the above modules are examples of the functions which may be implemented and are not intended to limit the kinds of modules which may be implemented. Rather, in some embodiments, these modules, along with others, may be implemented alone or in combination, as one of ordinary skill in the relevant art(s) would appreciate.

Any reference in this specification to “one embodiment,” “an embodiment,” “some embodiments,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments. Furthermore, for ease of understanding, certain method procedures may have been delineated as separate procedures; however, these separately delineated procedures should not be construed as necessarily order dependent in their performance. That is, some procedures may be able to be performed in an alternative ordering or simultaneously, as one or ordinary skill would appreciate based at least on the teachings provided herein.

Embodiments of the present invention may be described in sufficient detail to enable those skilled in the art to practice the invention. Other embodiments may be utilized, and structural, logical, and intellectual changes may be made without departing from the scope of the present invention. Moreover, it is to be understood that various embodiments of the invention, although different, are not necessarily mutually exclusive. For example, a particular feature, structure, or characteristic described in one embodiment may be included within other embodiments. Accordingly, the detailed description is not to be taken in a limiting sense.

The foregoing embodiments and advantages are merely exemplary and are not to be construed as limiting the present invention. For instance, the present teaching can be readily applied to other types of memories. Those skilled in the art can appreciate from the foregoing description that the techniques of the embodiments of the invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

What is claimed is:

1. A system comprising:
an application domain, wherein the application domain includes a non-critical application component, and wherein the application domain is a first virtual machine;
an engine domain, wherein the engine domain includes a critical application component, and wherein the engine domain is secure, and wherein the engine domain is a second virtual machine;
an inter-domain communication channel to couple the application domain to the engine domain, and wherein the inter-domain communication channel is secure; and
a virtual machine monitor coupled to the first and second virtual machines and to the inter-domain communication channel, the virtual machine monitor to supervise communication between the application domain and the engine domain.

2. The system of claim 1, wherein the application domain further comprises:
a user-level translation layer; and
a kernel-level translation layer, wherein the user-level translation layer is adapted to transfer control from the user-level translation layer to the kernel-level translation layer, and to respond to calls from the kernel-level translation layer, and wherein the kernel-level translation layer is adapted to send notifications to the engine domain, to respond to notifications sent by the engine domain, to transfer control from the kernel-level translation layer to the user-level translation layer, and to transfer data between the kernel-level translation layer and the user-level translation layer.

3. The system of claim 1, wherein the engine domain further comprises:
a user-level translation layer; and
a kernel-level translation layer.

4. The system of claim 3, wherein the user-level translation layer comprises:
a parameter check service module;
an encryption service module; and
an integrity check service module.

5. The system of claim 1, wherein the non-critical application component is a graphical user interface for a voice over internet protocol application, and the critical application component is a voice over internet protocol communication stack.

6. The system of claim 1, wherein the non-critical application component and the critical application component are parts of a collaboration application.

7. The system of claim 6, wherein the collaboration application is a voice over internet protocol application, an electronic mail application, an instant messaging application, a multi-player game application, a video-on-demand application, or a secure billing application.

8. The system of claim 1, wherein more than one non-critical application component is included in the application domain.

9. The system of claim 1, wherein more than one application domain is included in the system.

10. The system of claim 1, wherein more than one critical application component is included in the engine domain.

11. The system of claim 1, wherein more than one engine domain is included in the system.

12. A method comprising:
receiving a request to run a collaboration application, wherein the collaboration application includes at least one non-critical component and at least one critical component;
running the non-critical component in an application domain on a first virtual machine;
running the critical component in an engine domain on a second virtual machine; and
linking the first and second virtual machines with an inter-domain communication channel.

13. The method of claim 12, further comprising:
separating a collaboration application into a non-critical component and a critical component.

14. The method of claim 12, further comprising:
monitoring the first and second virtual machines, and the inter-domain communication channel with a virtual machine monitor, wherein the virtual machine monitor supervises communication between the application domain and the engine domain.

15. The method of claim 12, further comprising:
running a user-level translation layer in the application domain; and
running a kernel-level translation layer in the application domain, wherein the user-level translation layer is adapted to transfer control from the user-level translation layer to the kernel-level translation layer, and to respond to calls from the kernel-level translation layer, and wherein the kernel-level translation layer is adapted to send notifications to the engine domain, to respond to notifications sent by the engine domain, to transfer control from the kernel-level translation layer to the user-level translation layer, and to transfer data between the kernel-level translation layer and the user-level translation layer.

16. The method of claim 12, further comprising:
running a user-level translation layer in the engine domain; and
running a kernel-level translation layer in the engine domain.

17. The method of claim 16, wherein the running of the user-level translation layer further comprises:
running a parameter check service module;
running an encryption service module; and
running an integrity check service module.

18. The method of claim 12, wherein the non-critical application component is a graphical user interface for a voice over internet protocol application, and the critical application component is a voice over internet protocol communication stack.

19. The method of claim 12, wherein the collaboration application is a voice over internet protocol application, an electronic mail application, an instant messaging application, a multi-player game application, a video-on-demand application, or a secure billing application.

20. The method of claim 12, wherein more than one non-critical application component is included in the application domain.

21. The method of claim 12, wherein more than one application domain is running.

22. The method of claim 12, wherein more than one critical application component is included in the engine domain.

23. The method of claim 12, wherein more than one engine domain is running.

24. A machine readable medium containing program instructions that, when executed, cause the machine to:
receive a request to run a collaboration application, wherein the collaboration application includes at least one non-critical component and at least one critical component;
run the non-critical component in an application domain on a first virtual machine;
run the critical component in an engine domain on a second virtual machine; and
link the first and second virtual machines with an inter-domain communication channel.

25. The machine readable medium of claim 24, further comprising:
separate a collaboration application into a non-critical component and a critical component.

26. The machine readable medium of claim 24, further comprising:
monitor the first and second virtual machines, and the inter-domain communication channel with a virtual machine monitor, wherein the virtual machine monitor supervises communication between the application domain and the engine domain.

27. The machine readable medium of claim 24, further comprising:
run a user-level translation layer in the application domain; and
run a kernel-level translation layer in the application domain, wherein the user-level translation layer is adapted to transfer control from the user-level translation layer to the kernel-level translation layer, and to respond to calls from the kernel-level translation layer, and wherein the kernel-level translation layer is adapted to send notifications to the engine domain, to respond to notifications sent by the engine domain, to transfer control from the kernel-level translation layer to the user-level translation layer, and to transfer data between the kernel-level translation layer and the user-level translation layer.

28. The machine readable medium of claim 24, further comprising:
run a user-level translation layer in the engine domain; and
run a kernel-level translation layer in the engine domain.

29. The machine readable medium of claim 28, wherein the running of the user-level translation layer further comprises:
run a parameter check service module;
run an encryption service module; and
run an integrity check service module.

30. The machine readable medium of claim 24, wherein the non-critical application component is a graphical user interface for a voice over internet protocol application, and the critical application component is a voice over internet protocol communication stack.

31. The machine readable medium of claim 24, wherein the collaboration application is a voice over internet protocol application, an electronic mail application, an instant messaging application, a multi-player game application, a video-on-demand application, or a secure billing application.

32. The machine readable medium of claim 24, wherein more than one non-critical application component is included in the application domain.

33. The machine readable medium of claim 24, wherein more than one application domain is adapted to run.

34. The machine readable medium of claim 24, wherein more than one critical application component is included in the engine domain.

35. The machine readable medium of claim 24, wherein more than one engine domain is adapted to run.
